(19) United States
(12) Patent Application Publication
(10) Pub. No.: US 2026/0186643 A1
(43) Pub. Date: Jul. 2, 2026

(54) DISPLAY DEVICE AND OPERATING METHOD THEREOF

(71) Applicant: LG ELECTRONICS INC., Seoul (KR)

(72) Inventors: Daegun Park, Seoul (KR); Yurim Oh, Seoul (KR); Yeonoh Nam, Seoul (KR); Seunghye Park, Seoul (KR); Jungjae Lee, Seoul (KR)

(73) Assignee: LG ELECTRONICS INC., Seoul (KR)

(21) Appl. No.: 19/436,777

(22) Filed: Dec. 30, 2025

(30) Foreign Application Priority Data
Dec. 31, 2024 (WO) PCT/KR2024/021547

(51) Int. Cl. G06F 3/04845; G06F 3/16; H04N 21/431; H04N 21/485

(52) U.S. Cl. CPC G06F 3/04845; G06F 3/167; H04N 21/431; H04N 21/4854

(57) ABSTRACT

A display device can include a display configured to display a content video; and a controller configured to receive a command while displaying the content video, obtain a keyword related to a picture quality from the received command, compare a current setting value of a picture quality element related to the obtained keyword with one or more reference values, and display, on the display, a recommendation UI (User Interface) including a plurality of recommended picture quality items in which values of detailed items of the picture quality element are changed based on a comparison result.

### CROSS-REFERENCE TO RELATED APPLICATION

Pursuant to 35 U.S.C. § 119(a), this application claims priority to PCT Application No. PCT/KR2024/021547, filed on Dec. 31, 2024, the entity of which is incorporated by reference into the present application.

### BACKGROUND OF THE INVENTION

### 1. Field of the Invention

This disclosure relates to a display device, and more specifically, to a display device that may recommend a picture quality or a sound quality.

### 2. Discussion of the Related Art

Digital TV services using wired or wireless communication networks are becoming common. Digital TV services may provide various services which cannot be provided by the existing analog broadcast service.

For example, Internet protocol television (IPTV) and smart TV services which are types of digital TV services provide interactivity to allow user to actively select a type of a program to be watched, a viewing time, etc. The IPTV and smart TV services may provide various additional services, such as Internet search, home shopping and online games, based on such interactivity.

Additionally, as TVs become more advanced, picture quality-related settings are becoming more and more detailed. For example, brightness settings are subdivided into specialized functions such as OLED Pixel Brightness, Adjust Contrast, Black Level, Auto Dynamic Contrast, and Peak Brightness.

As TV's artificial intelligence-based services and functions become more diverse and detailed, it is becoming increasingly difficult for anyone except users who are familiar with technology to experience artificial intelligence-based smart functions.

This causes a gap in the TV usage experience between users, and users who have difficulty experiencing artificial intelligence-based smart functions do not feel the utility of the purchase price.

### SUMMARY OF THE INVENTION

The purpose of the present disclosure may be to reduce accessibility to advanced functions, such as artificial intelligence-based picture quality customization or sound quality customization, even for non-experienced users.

The purpose of the present disclosure may be to recommend a picture quality improvement plan with appropriate balancing without a separate application or a separate professional knowledge.

The purpose of the present disclosure may be to recommend the picture quality or the sound quality desired by the user through simple utterance.

A display device according to an embodiment of the present disclosure may A display device according to an embodiment of the present disclosure may comprise a display configured to display a content video; and a controller configured to receive a command while displaying the content video, obtain a keyword related to a picture quality from the received command, compare a current setting value of a picture quality element related to the obtained keyword with one or more reference values, and display, on the display, a recommendation UI (User Interface) including a plurality of recommended picture quality items in which values of detailed items of the picture quality element are changed based on a comparison result.

A method of operating a display device according to an embodiment of the present disclosure may comprise displaying a content image; receiving a command while displaying the content video; obtaining a keyword related to a picture quality from the received command; comparing a current setting value of a picture quality element related to the obtained keyword with one or more reference values; and displaying a recommendation UI (User Interface) including a plurality of recommended picture quality items in which values of detailed items of the picture quality element are changed based on a comparison result.

According to various embodiments of the present disclosure, even if the user is not an experienced user, accessibility to advanced functions such as artificial intelligence-based picture quality customization or sound quality customization is reduced, thereby improving user experience.

According to various embodiments of the present disclosure, a user may receive a recommendation for desired image or sound quality just by making a simple speech.

According to various embodiments of the present disclosure, even without expert knowledge, the optimal picture or sound quality of a display device may be recommended, thereby increasing the effectiveness of using the device.

### BRIEF DESCRIPTION OF THE DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 shows an example of an actual configuration of a remote control device according to an embodiment of the present disclosure.

FIG. 4 shows an example of using a remote control device according to an embodiment of the present disclosure.

FIG. 5 is a diagram for explaining the configuration of a system according to an embodiment of the present disclosure.

FIGS. 6A to 6C are diagrams illustrating a menu for setting a brightness, a color, and a sharpness of a screen according to an embodiment of the present disclosure.

FIG. 7 is a flowchart for explaining a method of operating a display device according to an embodiment of the present disclosure.

FIG. 8 is a diagram explaining the process of determining whether picture quality or sound quality may be recommended according to an embodiment of the present disclosure.

FIGS. 9A and 9B are diagrams illustrating an operation based on a comparison result between a current setting value of a picture quality element or a sound quality element and one or more reference values according to an embodiment of the present disclosure.

FIGS. 10A to 10D are diagrams showing an example of providing a recommendation UI including a plurality of recommendation items according to an embodiment of the present disclosure.

FIG. 11 is a diagram showing description information on recommended picture quality items according to a user's voice command according to an embodiment of the present disclosure.

FIG. 12 is a diagram illustrating handling when the picture quality of a content video changes while selecting a recommended picture quality item according to an embodiment of the present disclosure.

FIGS. 13A, 13B and 13C are diagrams illustrating an example in which items for accessing a recommended UI according to an embodiment of the present disclosure are reflected on each picture quality menu.

FIG. 14 is a diagram illustrating a process of providing recommended picture quality or sound quality based on a user's voice command and log data according to an embodiment of the present disclosure.

### DETAILED DESCRIPTION OF THE PREFERRED EMBODIMENTS

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

The display device according to an embodiment of the present disclosure is, for example, an intelligent display device in which a computer support function is added to a broadcast reception function, and is faithful to a broadcast reception function and has an Internet function added thereto, such as a handwritten input device, a touch screen Alternatively, a more user-friendly interface such as a spatial remote control may be provided. In addition, it is connected to the Internet and a computer with the support of a wired or wireless Internet function, so that functions such as e-mail, web browsing, banking, or games may also be performed. A standardized general-purpose OS may be used for these various functions.

Accordingly, in the display device described in the present disclosure, various user-friendly functions may be performed because various applications may be freely added or deleted, for example, on a general-purpose OS kernel. More specifically, the display device may be, for example, a network TV, HBBTV, smart TV, LED TV, OLED TV, and the like, and may be applied to a smart phone in some cases.

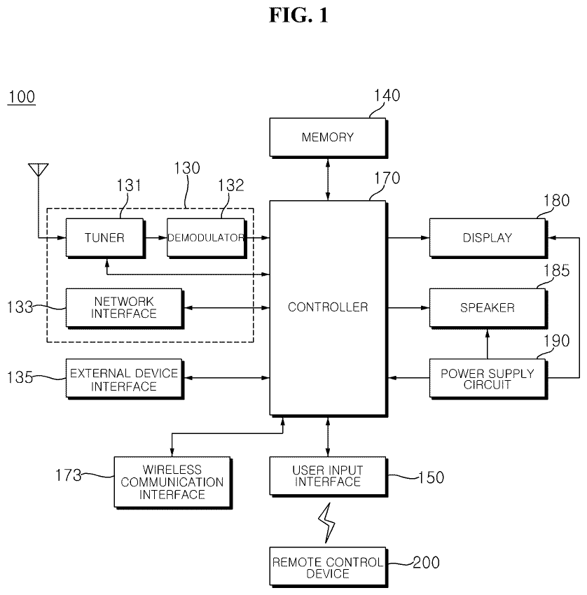

FIG. 1 is a block diagram showing a configuration of a display device according to an embodiment of the present disclosure.

Referring to FIG. 1, a display device 100 may include an image receiver 130, an external device interface 135, a memory 140, a user input interface 150, a controller 170, a wireless communication interface 173, a display 180, a speaker 185, and a power supply circuit 190.

The image receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface unit 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

The network interface 133 may provide an interface for connecting the display device 100 to a wired/wireless network including an Internet network. The network interface 133 may transmit or receive data to or from other users or other electronic devices through a connected network or another network linked to the connected network.

In addition, a part of content data stored in the display device 100 may be transmitted to a selected user among a selected user or a selected electronic device among other users or other electronic devices registered in advance in the display device 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a content provider or a network operator. That is, the network interface 133 may receive content such as movies, advertisements, games, VOD, and broadcast signals and information related thereto provided from a content provider or a network provider through a network.

In addition, the network interface 133 may receive update information and update files of firmware provided by the network operator, and may transmit data to an Internet or content provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface unit or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi(Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100.

Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 the speaker 185.

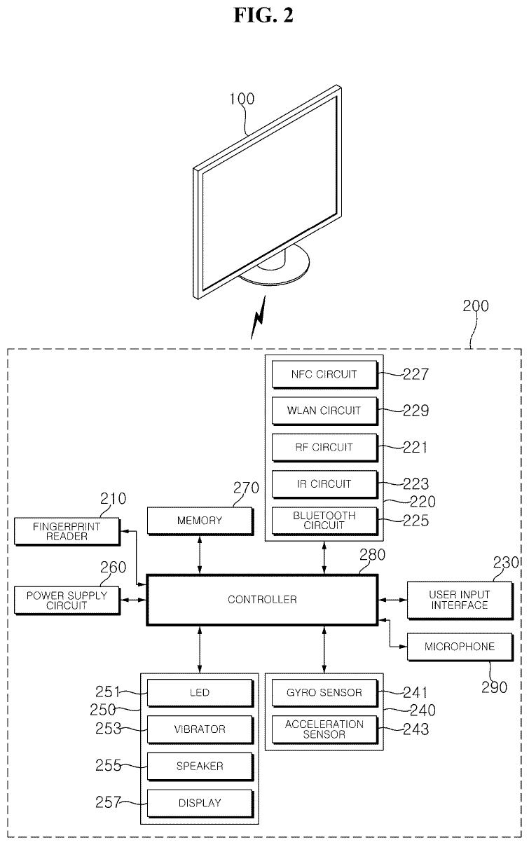

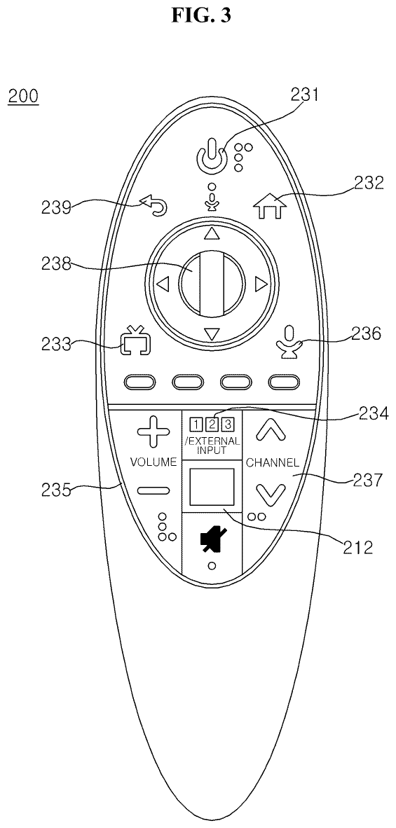

Next, a remote control device according to an embodiment of the present disclosure will be described with reference to FIGS. 2 to 3.

FIG. 2 is a block diagram of a remote control device according to an embodiment of the present disclosure, and FIG. 3 shows an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC (near field communication) communication standard, and a WLAN circuit 229 capable of transmitting and receiving signals to and from the display device 100 according to the wireless LAN (WLAN) communication standard.

In addition, the remote control device 200 may transmit a signal containing information on the movement of the remote control device 200 to the display device 100 through the wireless communication circuit 220.

In addition, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button. Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation.

The power button 231 may be a button for turning on/off the power of the display device 100.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the level of the volume output by the display device 100.

The voice recognition button 236 may be a button for receiving a user's voice and recognizing the received voice.

The channel change button 237 may be a button for receiving a broadcast signal of a specific broadcast channel.

The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100.

The user may recognize whether the user input interface 230 is operated or whether the display device 100 is controlled through the output interface 250.

For example, the output interface 450 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication unit 225.

In addition, the power supply circuit 260 may supply power to the remote control device 200, and stop power supply when the remote control device 200 has not moved for a predetermined time to reduce power consumption.

The power supply circuit 260 may restart power supply when a predetermined key provided in the remote control device 200 is operated.

The memory 270 may store various types of programs and application data required for control or operation of the remote control device 200.

When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 230 or a signal corresponding to the movement of the remote control device 200 sensed by the sensor 240 through the wireless communication unit 225.

Also, the microphone 290 of the remote control device 200 may obtain a speech.

A plurality of microphones 290 may be provided.

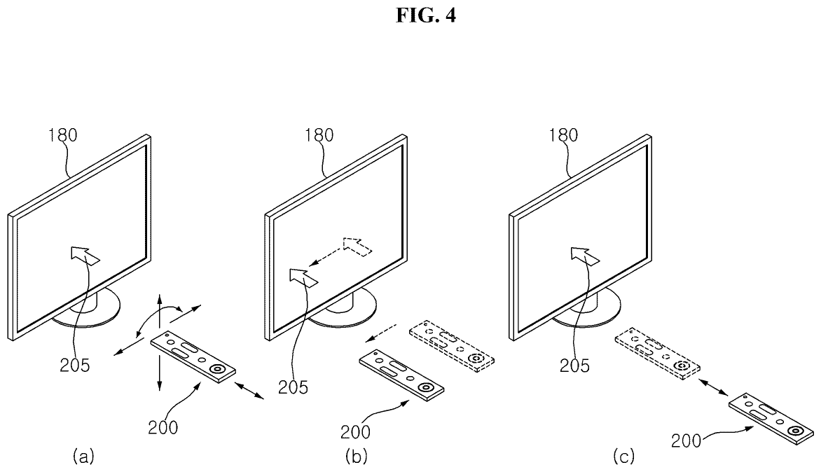

Next, a description will be given referring to FIG. 4.

FIG. 4 shows an example of using a remote control device according to an embodiment of the present disclosure.

In FIG. 4, (a) illustrates that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

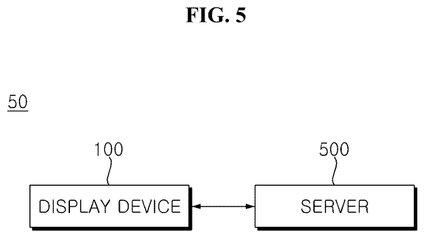

FIG. 5 is a diagram for explaining the configuration of a system according to an embodiment of the present disclosure.

Referring to FIG. 5, system 50 may include a display device 100 and a server 500.

The display device 100 may perform Internet communication with the server 500 through the network interface 133. The server 500 may include a Speech To Text (STT) server that converts voice signal into text data, and a Natural Language Processing (NLP) server that extracts keywords from the text data or obtains an analysis result.

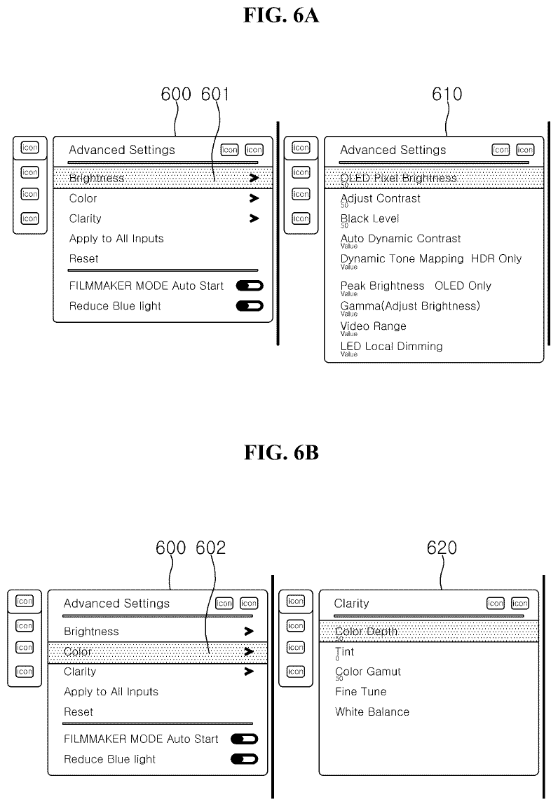

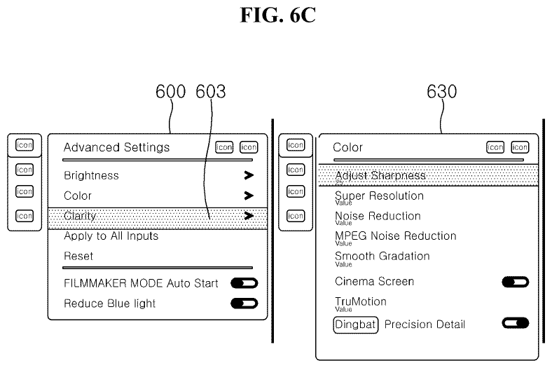

FIGS. 6A to 6C are diagrams illustrating a menu for setting a brightness, a color, and a sharpness of a screen according to an embodiment of the present disclosure.

Referring to FIG. 6A, a picture quality detailed setting menu 600 is shown. When a brightness item 601 included in the picture quality detailed settings menu 600 is selected, a brightness menu 610 for detailed brightness settings may be displayed. The brightness menu 610 may include detailed brightness items for detailed brightness settings, such as OLED Pixel Brightness, Adjust Contrast, Black Level, Auto Dynamic Contrast, and Peak Brightness.

Referring to FIG. 6B, when a color item 602 included in the picture quality detailed settings menu 600 is selected, a color menu 620 for detailed color settings may be displayed. The color menu 620 may include detailed color items for detailed color settings, such as color depth, tint, color gamut, and white balance.

Referring to FIG. 6C, when a sharpness item 603 included in the picture quality detailed settings menu 600 is selected, a sharpness menu 630 for detailed sharpness settings may be displayed. The sharpness menu 630 may include sharpness details for setting detailed sharpness, such as Adjust Sharpness, Super Resolution, Noise Reduction, MPEG Noise Reduction, Smooth Gradation, and TruMotion.

In this way, as the display device 100 becomes more advanced, settings related to picture quality become increasingly detailed and specialized.

However, it is increasingly difficult for anyone other than users familiar with these picture quality settings to experience artificial intelligence-based smart functions.

This causes a gap in the TV usage experience between users, and users who have difficulty experiencing artificial intelligence-based smart functions do not feel the utility of the purchase price.

The present disclosure seeks to reduce accessibility to advanced functions such as artificial intelligence-based picture quality customization or sound quality customization even for non-experienced users.

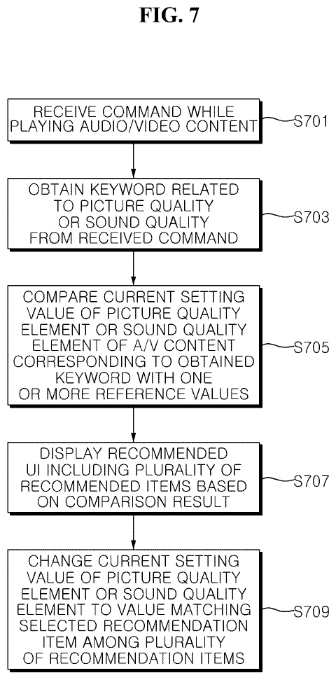

FIG. 7 is a flowchart for explaining a method of operating a display device according to an embodiment of the present disclosure.

Hereinafter, a picture quality elements or a sound quality element may have basic setting values and detailed setting values. For example, the basic setting value of the picture quality element called sharpness may have a value in the range of 0 to 100, and each setting value of the detailed items of sharpness may have a value in the range of 0 to 100 or a value of <low, medium, high>.

Referring to FIG. 7, the controller 170 may receive a command while playing audio/video content (S701).

In one embodiment, the command may be a voice command uttered by the user. The controller 170 may receive the voice command from the microphone provided in the user input interface 150 or the remote control device 200.

In another embodiment, the command may be a text command received through an execution screen of a chatbot application. The chatbot application may be artificial intelligence-based interactive software that helps users interact with the display device 100. The chatbot application may be installed on the display device 100. The chatbot application may be operated through a user's voice input or a user's text input.

In another embodiment, the command may be a manipulation command for manipulating a setting UI to adjust setting values of the picture quality element or the sound quality element. The manipulation command may be received from the remote control device 200.

The controller 170 may automatically execute the chatbot application upon receiving a command. The controller 170 may display the execution screen of the chatbot application on an area that does not interfere with the viewing of A/V content.

The controller 170 may obtain a keyword related to the picture quality or the sound quality from the received command (S703).

In one embodiment, when the received command is a voice command, the controller 170 may transmit the voice command to the server 500 through the network interface 133. The server 500 may convert the voice command into a text through the STT (Speech To Text) engine and extract an analysis result of the voice command from the converted text through the NLP (Natural Language Processing) engine. The analysis result may include one or more of the intent analysis result or keyword of the voice command.

The server 500 may tag a part of speech such as a noun, a verb, and an adjective that are likely to become the keyword, and extract an important word related to the picture quality or the sound quality by identifying an relationship between words in the tagged part of speech.

In one embodiment, the server 500 may obtain the extracted important word as the keyword. For example, when the user's voice command is <increase brightness>, the server 500 may obtain the important word and the keyword as <brightness>.

In another embodiment, the server 500 may obtain the picture quality element or the sound quality element corresponding to the extracted important word as the keyword. For example, when the user's voice command is <screen is too dark>, the server 500 may extract the important word as <screen, dark> and obtain the picture quality element corresponding to the extracted important word as the brightness.

The server 500 may transmit the analysis result including the obtained keyword to the display device 100.

In one embodiment, when the received command is a voice command, the controller 170 may independently extract the keyword related to the picture quality or the sound quality from the voice command. The controller 170 may convert the voice command into a text through the STT engine and obtain an analysis result of the voice command from the text converted through the NLP engine. The controller 170 may extract the keyword from the analysis result. Since the keyword extraction process is the same as the operation performed by the server 500, detailed description will be omitted.

In another embodiment, when the received command is a text command received through the execution screen of the chatbot application, the controller 170 may extract the keyword from the text command through an NLP engine. The text command may be a command based on a signal received from the remote control device 200.

In another embodiment, if the command is the manipulation command for manipulating the setting UI, the controller 170 may extract the picture quality element or the sound quality element matching the setting UI as the keyword.

Meanwhile, the controller 170 may determine whether it is possible to recommend the picture quality or the sound quality corresponding to the obtained keyword.

FIG. 8 is a diagram illustrating a process for determining whether the picture quality or the sound quality may be recommended according to an embodiment of the present disclosure.

FIG. 8 may be an operation performed after step S703.

The controller 170 may determine whether it is possible to recommend the picture quality or the sound quality corresponding to the obtained keyword (S801).

If the controller 170 determines that it is possible to recommend the picture quality or the sound quality corresponding to the obtained keyword, step S705 may be performed.

In one embodiment, the controller 170 may determine that it is impossible to recommend the picture quality or the sound quality if an A/V content provider restricts the picture quality or the sound quality control through a policy.

If the controller 170 determines that it is impossible to recommend the picture quality or the sound quality corresponding to the obtained keyword, it may display a notification that a recommendation is not available on the display 180 (S803).

Again, FIG. 7 will be described.

The controller 170 may compare a current setting value of the picture quality element or the sound quality element of the A/V content corresponding to the obtained keyword with one or more reference values (S705).

In one embodiment, there may be one reference value. When one reference value is provided, the reference value may be either a maximum value or a minimum value of the corresponding the picture quality element or the sound quality element.

In another embodiment, a plurality of reference values may be provided. When two reference values are provided, each reference value may represent an upper limit and a lower limit.

The current setting value of the picture quality element or the sound quality element may be referred to as a default setting value.

The controller 170 may display a recommended user interface (UI) including a plurality of recommended items on the display 180 based on the comparison result (S707).

In one embodiment, the controller 170 may display the recommendation UI including the plurality of recommended items on the display 180 when the current setting value of the picture quality element or the sound quality element related to the keyword is greater than a first reference value or less than a second reference value that is less than the first reference value.

The controller 170 may obtain the plurality of recommended items based on comparison result and the analysis result indicating an intention of the command.

If the current setting value of the picture quality element related to the keyword is less than the first reference value and greater than the second reference value, the controller 170 may change the current setting value of the corresponding picture quality element or the sound quality element.

In another embodiment, the controller 170 may display the recommendation UI including the plurality of recommendation items on the display 180 when the current setting value of the picture quality element or the sound quality element is the maximum value or minimum value.

The plurality of recommended items may include either a plurality of recommended picture quality items or a plurality of recommended sound quality items. The recommendation UI may further include a current video item indicating the video of the A/V content currently being viewed for a comparison with the recommended picture quality item. The current video item may include picture quality information about the video of the A/V content being viewed.

In one embodiment, the controller 170 may determine the values of the detailed items of the picture quality element related to the keyword based on at least one of a current setting value of the picture quality element related to the keyword, current setting values of the detailed items of the picture quality element, a genre of the A/V content being viewed, or information about an application that drives (or triggers) the execution of the A/V content. The controller 170 may generate a recommended picture quality video that matches the values of the detailed items of the picture quality element, and may generate the generated recommended picture quality video as a recommended picture quality item. A plurality of recommended picture quality items may be generated by combining values of detailed items of picture quality elements.

In another embodiment, the controller 170 may determine the values of the detailed items of the picture quality element related to the keyword and the values of the detailed items of the other picture quality element based on at least one of the current setting value of the picture quality element related to the keyword, the current setting values of the detailed items of the picture quality element, the genre of the A/V content being watched, information about the application that drives (or triggers) the execution of the A/V content, the current setting value of the other picture quality element, or the current setting value of the detailed items of the other picture quality element. Other picture quality elements may be elements closely related to the picture quality element. For example, a sharpness and a color may be picture quality elements that are closely related to each other.

In another embodiment, the controller 170 may determine the detailed item values of the sound quality element related to the keyword based on at least one of the current setting value of the sound quality element related to the keyword, current setting values of detailed items of the sound quality element, information about the currently running application, or the genre of the A/V content being viewed. The controller 170 may generate recommended sound quality items that match the values of detailed items of sound quality elements.

In another embodiment, the controller 170 may generate a plurality of recommended items based on a user's preference log data. The user's preferred log data may include at least one of preferred picture quality log data or preferred sound quality log data.

The preferred picture quality log data is data obtained through log data indicating picture quality information about a content video that a user has viewed in the past, and may include setting values of detailed items of each picture quality element corresponding to the user.

The preferred sound quality log data is data obtained through log data representing sound quality information about content that a user has viewed in the past, and may include setting values of detailed items of each sound quality element corresponding to the user.

The controller 170 or the server 500 may collect the log data when a user watches content and obtain preferred log data based on the collected log data. The log data may include setting information on picture quality elements and setting information on sound quality elements set when a user watches A/V content.

When the server 500 obtains preference log data, the server 500 may transmit the preference log data to the display device 100.

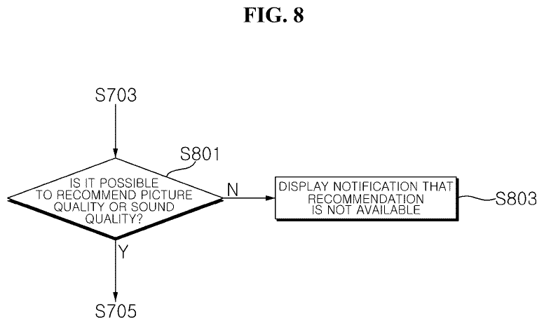

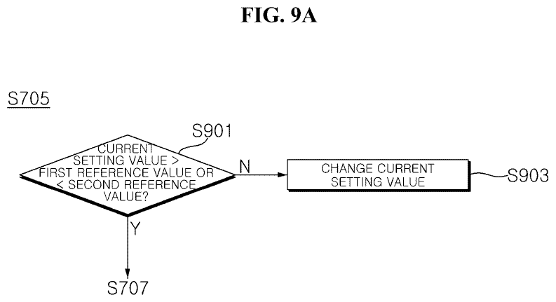

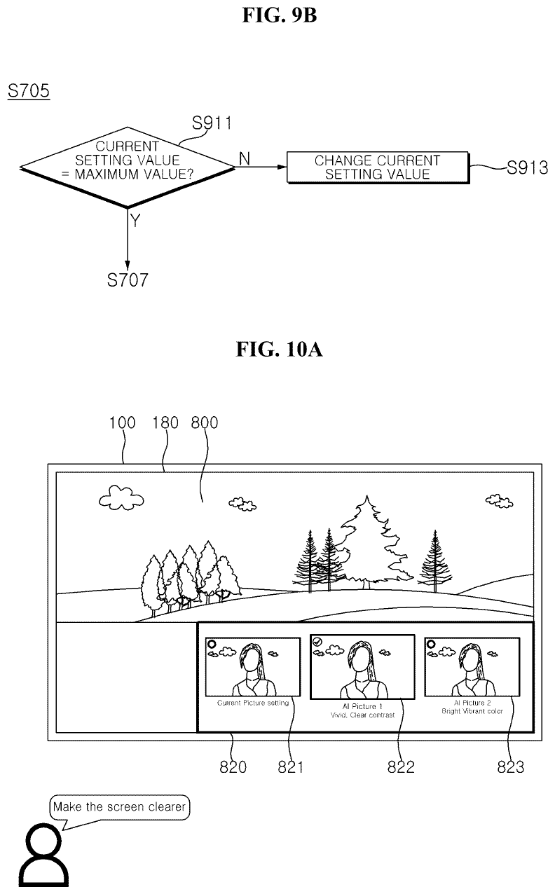

FIGS. 9A and 9B are diagrams illustrating an operation based on a comparison result between a current setting value of a picture quality element or a sound quality element and one or more reference values according to an embodiment of the present disclosure.

Referring to FIG. 9A, the controller 170 may perform step S707 when the current setting value of the picture quality element or the sound quality element related to the keyword is greater than a first reference value or the current setting value is less than a second reference value that is less than the first reference value (S901). If the current setting value of the picture quality element or the sound quality element related to the keyword is smaller than the first reference value and greater than the second reference value, the controller 170 may change the current setting value (S903).

If the current setting value of the picture quality element or the sound quality element related to the keyword is less than the first reference value and greater than the second reference value, the controller 170 may adjust the current setting value based on an analysis result of the voice command.

For example, if the user's voice command is <the screen is too dark>, the picture quality element related to the extracted keyword may be a brightness, and the analysis result may include an intention to increase the brightness of the screen. Additionally, when the picture quality element is the brightness, the first reference value may be 80 and the second reference value may be 20.

If the current setting value of the brightness is 50, which is between the first and second reference values, the controller 170 may increase the brightness from 50 to 70 according to the intention to increase the brightness of the screen.

When the current setting value of the brightness is 90, which exceeds the first reference value, the controller 170 may change a first setting value set of detailed brightness items to a second setting value set based on at least one of information about the currently running application and the genre of the A/V content being viewed. The setting value set may include setting values for detailed items of brightness. The detailed items of brightness may include OLED Pixel Brightness, Adjust Contrast, Black Level, Auto Dynamic Contrast, and Peak Brightness described in FIG. 6A.

For example, assume that the genre of the A/V content currently being played is a nature documentary, the running application is a video streaming application, and the first setting value set is as follows.
<OLED Pixel Brightness: 95, Adjust Contrast: 75, Black Level: 50, Auto Dynamic Contrast: Medium, Peak Brightness: Medium>

The controller 170 may change the second setting value set for detailed items of brightness as follows.
<OLED Pixel Brightness: 75, Adjust Contrast: 80, Black Level: 45, Auto Dynamic Contrast: Medium, Peak Brightness: Medium>

The controller 170 may generate a recommended picture quality item using the second setting value set. The controller 170 may generate a recommended video in which the setting values of detailed items of the brightness for the video of the A/V content being played are changed from the first setting value set to the second setting value set. The controller 170 may obtain the generated recommended video as the recommended picture quality item. The recommended video may be the video of the A/V content being played, or the default video may be used.

Referring to FIG. 9B, the controller 170 may perform step S707 when the current setting value of the picture quality element or the sound quality element related to the keyword is equal to a maximum value (S911).

For example, if the picture quality element to which the keyword is related is the brightness, and the current setting value of brightness has the maximum value of 100, the controller 170 may change the first setting value set for detailed items of the brightness to the second setting value set.

If the current setting value of the picture quality element or the sound quality element related to the keyword is not the maximum value, the controller 170 may change the current setting value (S913).

If the current setting value of the picture quality element or the sound quality element related to the keyword is the maximum value, the controller 170 may adjust the current setting value based on the analysis result of the voice command.

For example, if the user's voice command is <the screen is too dark>, the picture quality element related to the extracted keyword may be the brightness, and the analysis result may include the intention to increase the brightness of the screen.

The controller 170 may increase the brightness from 70 to 80 depending on the intention to increase the brightness of the screen, where the current brightness setting value is 70, which is less than the maximum value.

Again, FIG. 7 will be described.

When one of the plurality of recommendation items is selected, the controller 170 may change the current setting value of the picture quality element or the sound quality element of the A/V content to a value matching the selected recommendation item among the plurality of recommendation items (S709).

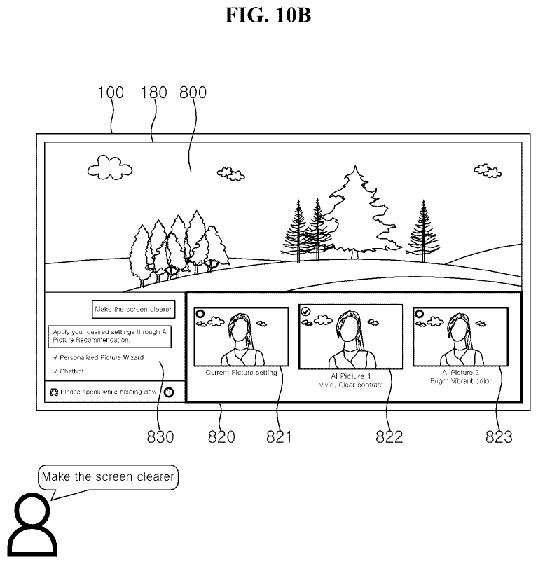

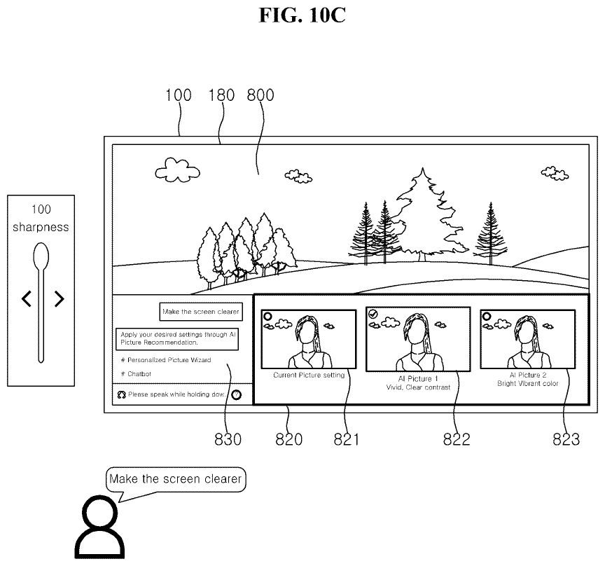

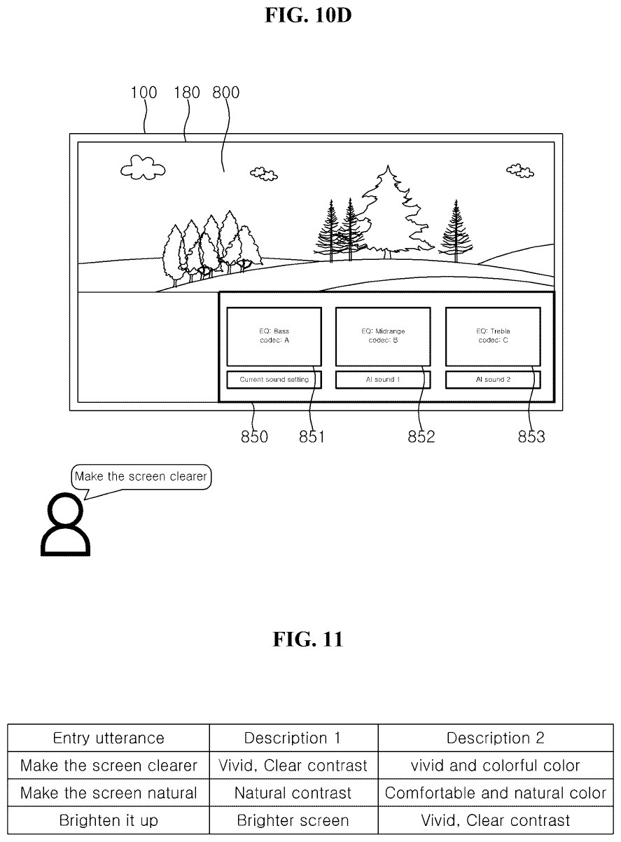

FIGS. 10A to 10D are diagrams showing an example of providing a recommendation UI including a plurality of recommendation items according to an embodiment of the present disclosure.

Referring to FIG. 10A, the display device 100 is playing a content video 800 on the display 180.

The display device 100 may receive a voice command <Make the screen clearer> uttered by the user. The display device 100 may extract keywords <screen, clearer> related to the picture quality from the voice command. The display device 100 may obtain an picture quality element called a sharpness based on at least one of the extracted keywords or the analysis result of the voice command (intent to make the screen clearer).

The display device 100 may compare the current setting value of the sharpness with one or more reference values. When the current setting value of sharpness is greater than the first reference value or less than the second reference value, the display device 100 may display a recommendation UI 820 including a plurality of recommended picture quality items 822 and 823 on the display 180. The recommendation UI 820 may be displayed overlapping the content video 800.

Each recommended picture quality item may include a recommended video that reflects recommended setting values of detailed items of the sharpness for the currently playing content video 800 or a default video.

Description information about picture the quality may be further displayed on one side of each recommended picture quality item. For example, the description information on the sharpness such as <ViVid, Clear contrast> may be displayed at a bottom of the first recommended picture quality item 822, and the description information on the sharpness such as <Bright, Vibrant color> may be displayed at a bottom of the second recommended picture quality item 823.

The description information about the picture quality may be included in each recommended picture quality item.

The recommendation UI 820 may further include a current picture quality item 821 corresponding to a current setting value of the sharpness for a comparison of the sharpness with the recommended picture quality item.

The user may compare the current picture quality item 821 and the plurality of recommended picture quality items 822 and 823 at a glance and select a desired recommended picture quality item.

The display device 100 may change the current setting values of detailed items of the sharpness for the content video 800 to setting values matching the selected recommended picture quality item according to an input for selecting one of the plurality of recommended picture quality items 822 and 823.

In this way, according to the embodiment of the present disclosure, the user may receive picture quality recommendation with a simple utterance and may access advanced functions such as picture quality customization.

Referring to FIG. 10b, the display device 100 may execute a chatbot application to guide the provision of recommended picture quality item and display an execution screen 830 of the chatbot application on the display 180.

The display device 100 may display the execution screen 830 of the chatbot application on the display 180 according to receiving a user's voice command. The execution screen 830 of the chatbot application may be displayed overlapping the content video 800.

The execution screen 830 may include a speech text corresponding to the voice command uttered by the user and a guide text guiding an AI picture quality recommendation.

The display device 100 may display the execution screen 830 of the chatbot application and the recommendation UI 820.

Referring to FIG. 10C, it is assumed that the default setting value of the sharpness is set to the maximum value of 100. The display device 100 may receive a voice command <Make the screen clearer> while playing the content video 800.

The display device 100 may obtain setting values for detailed items of the sharpness based on at least one of the genre of the content video 800 or information on the application that caused playback of the content video 800.

The display device 100 may display the recommendation UI 820 including recommended picture quality items 822 and 823 generated based on the setting values for detailed items of acquired sharpness.

FIG. 10D is an example of providing recommended sound quality items.

Referring to FIG. 10D, the display device 100 may receive a voice command <Make the sound clearer> uttered by the user. The display device 100 may extract keywords <sound, clearer> related to sound quality from the voice command. The display device 100 may obtain a sound quality element called a sound quality sharpness based on at least one of the extracted keywords or an analysis result of the voice command (intent to make the sound quality clearer).

The display device 100 may compare a default setting value of sound quality sharpness with one or more reference values. When the default setting value of sound quality sharpness is greater than a first reference value or less than a second reference value, the display device 100 may display a recommendation UI 850 including a plurality of recommended sound quality items 852 and 853 on the display 180. The recommendation UI 850 may be displayed overlapping the content video 800.

Each recommended sound quality item may include recommended setting values of detailed items of the sound quality sharpness for the currently playing content video 800 or the default video.

Each recommended sound quality item may display description information about the sound quality. For example, description information on the sound quality sharpness may be displayed such as <EQ: Midrange, codec: B> at a bottom of the first recommended sound quality item 852, and description information on clarity such as <EQ: Treble, codec: C> may be displayed at a bottom of the second recommended sound quality item 853.

The description information about sound quality may be included in each recommended sound quality item.

The recommendation UI 850 may further include a current sound quality item 851 corresponding to the current setting value of the sound quality sharpness for a comparison of the sound quality sharpness with the recommended sound quality item.

The user may select a desired recommended sound quality item by comparing the current sound quality item 851 and a plurality of recommended sound quality items 852 and 853 at a glance.

The display device 100 may change the current setting values of detailed sound quality sharpness items for the content video 800 to setting values matching the selected recommended sound quality item according to an input of selecting one of the plurality of recommended sound quality items 852 and 853.

In this way, according to the embodiment of the present disclosure, the user may receive sound quality recommendation with a simple utterance and may access advanced functions such as sound quality customization.

FIG. 11 is a diagram showing description information on recommended picture quality items according to a user's voice command according to an embodiment of the present disclosure.

Referring to FIG. 11, description information on recommended picture quality item is shown according to a type of voice command uttered by the user related to picture quality.

An entrance utterance may represent a voice command uttered by the user, and Description 1 and Description 2 may each represent description information of a recommended picture quality item corresponding to the voice command uttered.

FIG. 12 is a diagram illustrating handling when the picture quality of a content video changes while selecting a recommended picture quality item according to an embodiment of the present disclosure.

In FIG. 12, description of content overlapping FIG. 10B is omitted.

The display device 100 may detect a change in the picture quality of the video being played while displaying the recommendation UI 820. The content video 800 may be received from an external device connected through the external device interface 135. The display device 100 may detect that the picture quality of the screen changes as the external device changes.

When the picture quality of the screen changes (or when a screen mode changes), the display device 100 may end display of the recommendation UI 820 and may display an error message 1200 on the display 180 indicating that display of the recommendation UI 820 ends due to an error.

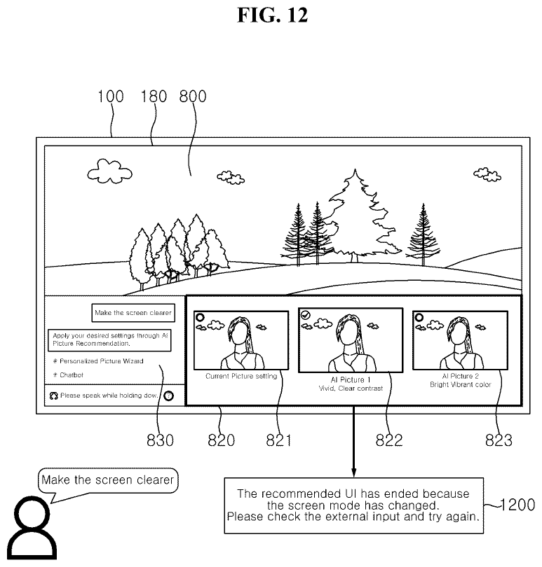

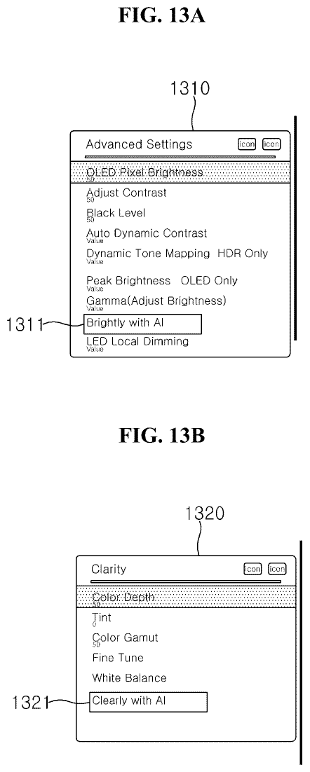

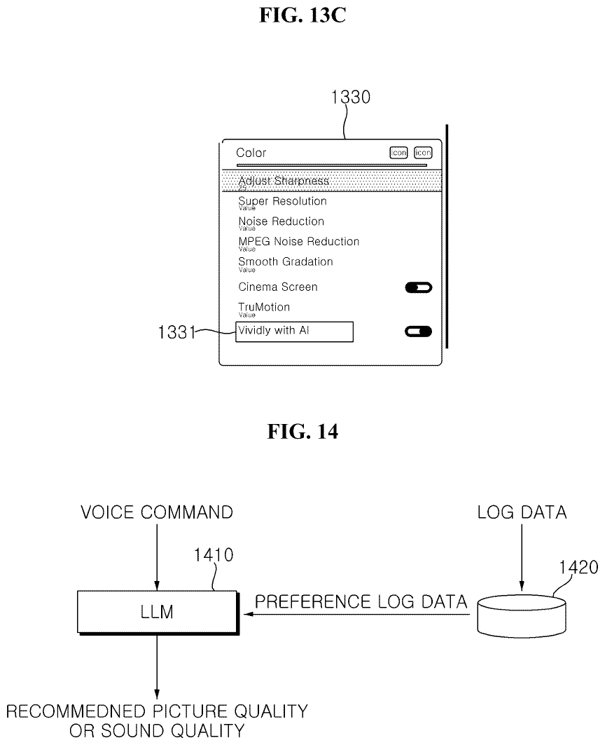

FIGS. 13A and 13B are diagrams illustrating an example in which an item for accessing a recommended UI according to an embodiment of the present disclosure is reflected on each picture quality menu.

Referring to FIG. 13A, when a brightness item included in the picture quality detailed setting menu is selected, a brightness menu 1310 may be displayed. The brightness menu 1310 may include detailed brightness items for detailed settings of the brightness and an AI brightness item 1311 The AI brightness item 1311 may be an item for providing a recommended UI while watching the content video, as shown in FIGS. 10A to 10C.

The display device 100 may display the recommendation UI including a plurality of recommended picture quality items on the display 180 according to a command for selecting the AI brightness item 1311 while watching the content video.

Referring to FIG. 13B, when a sharpness item included in the picture quality detailed settings menu is selected, a sharpness menu 1320 may be displayed. The sharpness menu 1320 may include sharpness detail items for detailed settings of the sharpness and an AI sharpness item 1321. The AI sharpness item 1321 may be an item for providing a recommended UI while watching the content video, as shown in FIGS. 10A to 10C.

The display device 100 may display a recommendation UI including a plurality of recommended picture quality items on the display 180 according to a command for selecting the AI clarity item 1321 while watching the content video.

Referring to FIG. 13C, when a color item included in the picture quality detailed settings menu is selected, a color menu 1330 may be displayed. The color menu 1330 may include detailed color items for detailed settings of a color and an AI color item 1331. The AI color item 1331 may be an item for providing a recommended UI while watching the content video, as shown in FIGS. 10A to 10C.

The display device 100 may display a recommendation UI including a plurality of recommended picture quality items on the display 180 according to a command for selecting the AI color item 1331 while watching the content video.

As such, according to an embodiment of the present disclosure, access to recommended picture quality may be facilitated by providing an AI item on the menu of picture quality element.

FIG. 14 is a diagram illustrating a process of providing recommended picture quality or sound quality based on a user's voice command and log data according to an embodiment of the present disclosure.

Referring to FIG. 14, the display device 100 may further include a large language model (Large Language Model, 1410) and a database 1420. The LLM 1410 and the database 1420 may be stored in the controller 170 or memory 140.

The database 1420 may store a user's log data and transmit preferred log data extracted based on the log data to the LLM 1410.

The controller 170 may collect the log data when a user watches content and obtain the preference log data based on the collected log data. The log data may include setting values for picture quality elements and setting values for sound quality elements set when a user watches A/V content.

The controller 170 may obtain picture quality preference log data for the user's preferred picture quality and sound quality preference log data for the user's preferred sound quality based on the log data.

The large language model (Large Language Model, 1410) may generate recommended picture quality information or recommended sound quality information based on text data corresponding to the user's voice command and the user's preference log data.

The recommended picture quality information may include setting values of detailed items of picture quality elements corresponding to each of a plurality of recommended sound quality items, and the recommended sound quality information may include detailed setting values of sound quality elements corresponding to each of a plurality of recommended sound quality items.

The controller 170 may obtain recommended picture quality information by inputting a voice command and preferred picture quality log data into the large language model 1410 and generate the plurality of recommended picture quality items based on the obtained recommended picture quality information.

According to an embodiment of the present disclosure, the above-described method may be implemented as processor-readable code on a program-recorded medium. Examples of media that the processor may read include ROM, RAM, CD-ROM, magnetic tape, floppy disk, and optical data storage devices.

The display device described above is not limited to the configuration and method of the above-described embodiments, and may be configured by selectively combining all or part of each embodiment so that various modifications may be made.

What is claimed is:

1. A display device, comprising:
a display configured to display a content video; and
a controller configured to:
receive a command while displaying the content video,
obtain a keyword related to a picture quality from the received command,
compare a current setting value of a picture quality element related to the obtained keyword with one or more reference values, and
display, on the display, a recommendation UI (User Interface) including a plurality of recommended picture quality items in which values of detailed items of the picture quality element are changed based on a comparison result.

2. The display device of claim 1, wherein the controller is configured to display the recommended UI on the display if the current setting value of the picture quality element is greater than a first reference value or less than a second reference value that is less than the first reference value.

3. The display device of claim 1, wherein the controller is configured to display the recommended UI on the display if the current setting value of the picture quality element is a maximum value.

4. The display device of claim 1, wherein the controller is further configured to:
determine the values of detailed items of the picture quality element based on at least one of the current setting value of the picture quality element, a genre of the content video, or application information that drives an execution of the content video, and
generate the plurality of recommended picture quality items matching the determined values of the detailed items.

5. The display device of claim 1, wherein the controller is further configured to:
determine the values of detailed items of the picture quality element and values of detailed items of other picture quality element based on at least one of the current setting value of the picture quality element, a setting value of the other picture quality element related to the picture quality element, a genre of the content video, or application information that drives an execution of the content video, and
generate the plurality of recommended picture quality items matching the determined values of the detailed items of the picture quality element and the values of the detailed items of the other picture quality element.

6. The display device of claim 1, wherein the controller is further configured to:
generate the plurality of recommended picture quality items based on preferred picture quality log data obtained through log data indicating picture quality information for a content video that the user has viewed in a past.

7. The display device of claim 6, wherein the controller is configured to:
input the command and the preferred picture quality log data into a large language model to obtain recommended picture quality information, and
generate the plurality of recommended picture quality items based on the obtained recommended picture quality information.

8. The display device of claim 1, wherein the controller is further configured to:
obtain an analysis result indicating an intent of the command, and
obtain the plurality of recommended picture quality items based on the comparison result and the analysis result.

9. The display device of claim 1, wherein the controller is configured to:
obtain an analysis result indicating an intent of the command, and
display the recommended UI if the intention of the command is to increase a value of the picture quality element based on the analysis result and the current setting value is greater than a reference value.

10. The display device of claim 1, wherein the controller is further configured to:
obtain an analysis result indicating an intention of the command, and
display the recommended UI if the intention of the command is to reduce a value of the picture quality element based on the analysis result and the current setting value is less than a reference value.

11. The display device of claim 1, wherein the controller is further configured to:
display, on the display, the content video reflecting the values of detailed items of the picture quality element corresponding to a selected recommended picture quality item based on a selection of one of the plurality of recommended picture quality items.

12. The display device of claim 1, wherein the command includes a voice command uttered by a user.

13. The display device of claim 1, wherein the controller is further configured to:
display a termination message for terminating the recommended UI on the display if a screen mode of the content video is changed.

14. The display device of claim 1, wherein the recommended UI further comprises a current video item representing the content video.

15. A method of operating a display device, comprising:
displaying a content image;
receiving a command while displaying the content video;
obtaining a keyword related to a picture quality from the received command;
comparing a current setting value of a picture quality element related to the obtained keyword with one or more reference values; and
displaying a recommendation UI (User Interface) including a plurality of recommended picture quality items in which values of detailed items of the picture quality element are changed based on a comparison result.
